(19) United States
(12) Patent Application Publication
(10) Pub. No.: US 2024/0219929 A1
(43) Pub. Date: Jul. 4, 2024

(54) ACQUISITION UNIT FOR AN INVENTORY CONTROL SYSTEM

(71) Applicant: Captana GmbH, Ettenheim (DE)

(72) Inventors: Thomas Schwarz, Hohberg (DE); Michael Unmüssig, Ettenheim (DE)

(21) Appl. No.: 18/560,130

(22) PCT Filed: May 18, 2021
(86) PCT No.: PCT/EP2021/063190

§ 371 Date: Nov. 10, 2023

(51) Int. Cl. G05D 1/661; G05D 111/30; H02J 50/10

(52) U.S. Cl. CPC G05D 1/661; H02J 50/10; G05D 2111/30

(57) ABSTRACT

The invention relates to an acquisition unit, which comprises at least one first sensor designed for acquiring a condition of a product presentation device, and a movement device which is designed for self-propelled movement of the acquisition unit within the product presentation device, and a holding or attachment device which is designed for automatically holding or attaching the acquisition unit to the product presentation device at the respective location of movement within the product presentation device.

### TECHNICAL FIELD

The invention relates to an acquisition unit having at least one sensor, and a movement device for moving the acquisition unit.

### BACKGROUND

Document EP 3020658 A1 discloses an inventory management system which uses an automated guided vehicle that scans articles on a shelf rack as it moves back and forth along a guideline. For this purpose, the inventory management system comprises a scanning unit comprising one or more antennas arranged vertically at locations corresponding to the heights of a shelf rack housing in order to detect information about articles placed in the shelf rack housing. The guidelines are located along one or more shelves. Furthermore, the vehicle is configured to assist the scanning unit to detect the guidelines and move along the guidelines. In addition, a control unit is provided which is configured to control the vehicle in such a way that the vehicle moves along the guidelines.

The inventory management system presented here has proved to be disadvantageous for several reasons, as follows. The detection range of the scanning unit is severely restricted due to the purely linear guidance along the guidelines. For example, if a large product is located on the shelf rack, the scanning unit cannot detect the region behind the product.

Even structural elements of the shelf rack or items on a shelf rack such as price labels cause blind spots, which means that the regions within the blind spots cannot be captured. Thus there are locations or regions on the shelf rack that cannot be captured for reasons inherent in the system.

This system also requires the creation of a pre-defined guideline network along the aisles of a store premises along which the vehicle can move. This severely limits the design freedom and flexibility with regard to the rack installation. Due to the predefined guideline network, no advertising boards such as customer stoppers or advertising columns, and also no sales stands, such as promotion baskets, can be placed in front of the shelves or near the shelves because these places are reserved for the guidelines and objects parked there would stand in the way of the vehicle.

This vehicle has at least the height of a shelf rack and is therefore very dominant in its appearance. This can act as a deterrent to customers, causing them for example to avoid aisles in which such a vehicle is currently moving.

Such a vehicle driving through the aisles can also be dangerous for customers, in particular children, who cannot perceive the approaching vehicle and then might collide with it.

Such a large vehicle, which requires at least one sensor for each shelf level to be scanned, is relatively expensive in production and maintenance. Also, the space required for a parked vehicle should not be underestimated and therefore has a negative effect on the space available for product presentation in the store premises.

The invention has therefore set itself the object of providing an improved acquisition unit and an improved product presentation device, in which the problems discussed above are overcome.

### SUMMARY OF THE INVENTION

This object is achieved by an acquisition unit according to claim 1. The subject matter of the invention is therefore an acquisition unit which comprises at least one first sensor designed to acquire a condition of a product presentation device, and a movement device which is designed for self-propelled movement of the acquisition unit within the product presentation device, and a holding or attachment device which is designed for automatically holding or attaching the acquisition unit to the product presentation device within the product presentation device at the respective location of movement.

Furthermore, this object is achieved by a product presentation device according to claim 11. The object of the invention is therefore a product presentation device, in particular a shelf rack or table, which comprises at least one acquisition unit according to the invention, at least one preparation zone which is designed for self-propelled movement of the acquisition unit, wherein the preparation zone is designed with regard to its surface quality and/or its material quality in such a way that the acquisition unit is held or attached to it autonomously by means of its holding or attachment device.

The measures according to the invention, therefore, have the advantage that for the first time a comprehensive acquisition of a condition of the product presentation device is possible with an acquisition unit from a position within the product presentation device.

In this case, the movement device of the acquisition unit ensures that the acquisition unit can move within the product presentation device substantially independently, or in other words in a self-propelled manner, in particular non-track-guided. In this case, the non-track-guided, self-propelled movement of the acquisition unit means that the acquisition unit does not follow any rail, cable or magnetic field and is therefore also not guided by such measures. This allows the acquisition unit to use its sensor within the product presentation device at very different positions and/or along very different motion paths—even at random positions and/or along random motion paths—for the purposes of acquisition.

The condition is therefore not acquired from outside the product presentation device, as is the case with known systems. Nor is the acquisition position of the sensor restricted to a path specified by mechanical guiding measures. In particular, in order to achieve the mobility of the sensor, in contrast to known measures the use of commonly existing bulky and complicated (electro-)mechanical components, which are located outside the product presentation device or provided within the product presentation device consuming space and are used for moving a sensor, is completely eliminated.

The mechanical coupling of the acquisition unit to the product presentation device is provided in the present case by the holding or attachment device. Because the holding or attachment device is fully integrated in the acquisition unit and therefore always moves together with the acquisition unit, it can also be used within the product presentation device independently of the respective location of the acquisition unit. The holding or attachment device acts in such a way that it holds the acquisition unit on the product presentation device against the effect of gravity and reliably prevents the acquisition unit from falling off. In this case, designs of the holding or attachment device are used which will be discussed in detail below and which pull the acquisition unit so strongly toward the product presentation device or cause such a strong, at least temporary, i.e. releasable attachment that the acquisition unit does not fall off the product presentation device, even under the effect of its own weight. This allows the acquisition unit to move along structural elements of the product presentation device extending obliquely upwards, which are oriented so steeply that without the holding or attachment device the structural element would tip over. The same applies to the movement on essentially vertical structural elements, from which the acquisition unit would fall off without the action of the holding or attachment device. The holding or attachment device, however, also allows overhead movement to be carried out, i.e. movements in which the acquisition unit is moved on the underside of the structural element free of any support, i.e. freely suspended. In particular, the last mentioned overhead movement has proved to have an extremely advantageous effect with regard to the ability to arbitrarily position the acquisition unit for the desired acquisition purposes, because this overhead movement takes place above products presented below it and can therefore be carried out unimpeded by these products. In this position, the acquisition unit is largely invisible from a customer's usual perspective, which completely avoids the previously mentioned aspects that are often disturbing or even dangerous to customers.

Further particularly advantageous designs and extensions of the invention arise from the dependent claims and the following description.

The product presentation device may, for example, be a shelf rack or a shelf rack region and comprise one or more rack levels, which are used for presentation of objects, in particular of products or goods. However, the product presentation device can also be a sales table or a sales stand, etc.

The condition, which can be acquired by means of the sensor, can relate to one or more (physical) quantities, the sensor being accordingly designed to carry out the corresponding acquisition of the relevant quantity. This means that sensor units corresponding to the different physical quantities can also be provided.

The condition may relate, for example, to the temperature prevailing in the product presentation device or of an object in the product presentation device. Accordingly, at least one sensor as a temperature sensor can be designed as an infrared camera or the like.

However, the condition may also relate to the lighting conditions prevailing in the product presentation device, wherein the sensor can accordingly be designed as a light sensor or a camera.

The condition may also be the presence or concentration of a specific gas or a mixture of gases. Such gases or gas mixtures can occur, for example, in perishable products such as fruit or vegetables or in products in which a release of unpleasantly smelling or even dangerous gases, such as found in solvents or paints, is possible. In this case, at least one sensor can be designed as a chemo-sensor or as a gas sensor.

The condition can also relate to the occupancy of a product presentation device. Occupancy may relate to the presence or absence of objects, the number of objects, the location or orientation of objects, the position of objects, etc. However, the occupancy may also relate, for example, to information in the form of a three-dimensional map of the product presentation device and the objects contained in it. A sensor designed for acquiring a condition regarding the occupancy can be, among others, a time-of-flight sensor, a camera or a 3D camera system, for example a time-of-flight camera.

The acquisition unit can be supplied with electrical energy via a cable that reels in or out automatically. Preferably, however, the acquisition unit comprises an electrical energy store, which can be implemented, for example, as a replaceable battery, as a rechargeable battery or as a supercapacitor. A solar panel can also be provided for autonomous energy supply to the acquisition unit, with the energy harvested or generated therewith being stored in a rechargeable energy store. The design with the solar panel is feasible because the acquisition unit, given its self-driving capability, can steer to a position at which there is sufficient incident light for charging the energy store.

In the case of a rechargeable energy storage device, the acquisition unit and the product presentation device may be designed for contactless (e.g. inductive) or contact-bound (e.g. with contacts or plug connectors) energy store charging.

Regardless of whether a rechargeable or a replaceable energy store is provided, it has been found to be advantageous that the acquisition unit is designed to approach an energy supply zone within the product presentation device by means of its movement device when the state of charge of its electrical energy store falls below a pre-defined level, in order to be supplied there with electrical energy for its operation.

In order to enable this without any problems, the product presentation device is designed such that the energy supply zone can be approached by the acquisition unit by means of the latter's movement device.

In the case of an exchangeable energy storage device, this energy supply zone is a position or a region in which a trained employee can remove the acquisition unit in as easily accessible a manner as possible and can replace the energy store or stores. The energy supply zone may be located here, for example, at the front edge of a ceiling of a shelf, so that an employee can easily locate the acquisition unit, remove it from the product presentation device as necessary, and replace the energy store(s) and, if appropriate, set down the acquisition unit at the energy supply zone. However, the energy supply zone may also be located in a region of the product presentation device that is only accessible to employees, for example in a box or service station (which may be automatically closing).

In the case of a rechargeable energy store, it is advantageous if the energy supply zone comprises a charging station or is located adjacent to one, wherein by means of the charging station, preferably by means of contactless energy transmission, the acquisition unit can be supplied with electrical energy. The acquisition unit therefore only needs to position itself autonomously in the energy supply zone in order to be supplied with energy there. The charging station in turn may be equipped with a replaceable battery, preferably a rechargeable battery, which has a sufficiently high charging capacity that frequent charging of the energy store of the acquisition unit is possible.

In the case of an acquisition unit equipped with a solar panel, the energy supply zone may be the region of the product presentation device in which there is simply only sufficient incident light for charging the energy store. For example, this energy supply zone can also be selected freely by the acquisition unit itself during its journey depending on the actual lighting conditions and can therefore change depending on the current route guidance or be defined by the acquisition unit itself. In order to ensure a good and adequate incidence of light for recharging the energy storage by means of a solar panel, even in the case of a covered or concealed positioning of the acquisition unit, the product presentation device may also be equipped with a mirror or a mirrored, possibly also light-focusing, zone, which introduces ambient light into the product presentation device.

The movement device comprises at least one drive element such as an electric motor, a linear motor or a linear actuator for providing a force or movement, and at least one transmission element for transmitting the force or movement to the environment.

The movement device may comprise leg-like (mechanical and/or electromechanical) structures with which the movement device-specific motion sequences and the force for generating the desired motion is transferred to the environment, that is, to the product presentation device. These leg-like structures may also comprise actuators that produce this force. However, they can also be driven by an actuator that is not located in the leg-like structures, for example by an electric motor.

According to a preferred embodiment, the movement device of the acquisition unit comprises at least one element from the following list, namely a wheel, a roller or drum, a chain, a belt and/or a ball. All these elements can be driven by an electric motor, and thus move the acquisition unit relative to its environment with which these elements interact.

The holding or attachment device ensures a, in particular reversible, connection of the acquisition unit to a corresponding counterpart, in particular to at least one preparation zone of the product presentation device. The holding or attachment device and the preparation zone can be formed in a number of different ways and matched to each other to ensure or guarantee that the acquisition unit is held on or attached to the preparation zone.

Thus the holding or attachment device can be a vacuum-operated holding or attachment device. For this purpose, for example, a fan or a pump may be provided, which is used to extract the air from the region that is located between the acquisition unit and the preparation zone during normal usage, so that the acquisition unit is held or attached to the preparation zone (also against gravity) as a result of the ambient pressure, or the reduced pressure (vacuum) in the region in which the air extraction operates. The vacuum-operated holding or attachment device is fully integrated into the movement device. For example, if the movement device comprises at least one roller or drum, these can comprise radial bores connected to an axial bore so that the air can be extracted through these bores directly at the contact point of the drum where the drum rests against the preparation zone. The remaining drum can be enclosed with a cover for this purpose, or the bores located there can be closed off with valves so that a sufficient pressure difference can be provided at the desired contact point. The movement device can also be equipped with suction cups. If, for example, the movement device comprises chains or belts equipped with suction cups, single or even multiple suction cups can simultaneously establish the attaching or holding contact between the acquisition unit and the preparation zone. In the context of the forms of embodiment discussed it has proved advantageous that the preparation zone interacting with the contact elements of the holding or attachment device is as smooth as possible, i.e. with low roughness, and is formed as flat as possible or with large radii, so that the contact elements of the vacuum-operated holding or vacuum-operated attachment device can be positioned there in a close-fitting manner. The holding or attaching contact elements of the vacuum-operated holding or attachment device can be activated and deactivated over the course of the movement in a targeted or sequential manner in order to always apply its holding or attaching effect at the right time or at the respective contact point.

The holding or attachment device can also be a detachable adhesive-holding or adhesive-attachment device. For this purpose, elements of the movement device, for example wheels or belts, can be surface-coated with a special coating, for example, a pressure-sensitive retaining adhesive or a sticky elastomer, wherein the coating temporarily connects to the preparation zone at the respective contact point in the movement sequence by adhesion and cohesion. An equivalent design can also be based on the principle of a Velcro fastener. These holding or attachment devices also establish their holding or attachment effect at the contact point that is established in the movement sequence.

Also, the holding or attachment device may be designed to be detached from the movement device and apply its effect in a sequentially controllable manner at different contact points that result in the course of the movement. This can be implemented, for example, by means of sequentially insertable struts, at the ends of which the contact elements of the holding or attachment device, which are used alternately, but with a slight temporal overlap in the movement sequence.

According to a preferred form of embodiment, however, the holding or attachment device is implemented by a magnetic holding device or magnetic attachment device. For this purpose the preparation zone consists essentially of a substance or material having ferromagnetic properties, such as iron or a ferritic steel, or any other material having similar properties. The holding or attaching effect for such a preparation zone is achieved by a magnet device or magnet arrangement in the acquisition unit. This magnet device may be formed with one magnet or with multiple magnets spaced apart from each other. The magnet(s) used for this purpose may be electromagnets or preferably permanent magnets. Here, too, the magnetic holding or attachment device can form a unit independent of the movement device or be integrated in the movement device. For example, the movement device of the acquisition unit may comprise four wheels and the magnetic holding or attachment device may comprise a permanent magnet which is placed in the middle of the four wheels, for example in the central position of the acquisition unit, in particular spaced equidistantly from the four wheels.

The use of one or more permanent magnets has proved to be extremely advantageous because the holding or attaching effect can be achieved without using any of the electrical energy stored in the energy store. The electrical energy stored in the energy store is thus available for the other electronic functions of the acquisition unit, unaffected by the holding and/or attachment effect.

The permanent magnet can be mounted flush with the surface of the acquisition unit housing or even inside the housing. Preferably, the permanent magnet protrudes from the acquisition unit in the direction of the preparation zone on which the wheels move. This allows the ideal distance to be set between the magnet and the preparation zone to achieve an optimal magnetic holding or attachment effect. The same can be achieved by adjusting the distance between the acquisition unit housing and the preparation zone if the permanent magnet does not protrude from the acquisition unit beyond the enclosure, as discussed above. In this case, it is essential to ensure that an air gap remains between the permanent magnet and the preparation zone, so that the force with which the acquisition unit magnetically pulls against the preparation zone does not become too strong and exceeds the capability of the movement device. In particular, a permanent magnet that completely adjoins the preparation zone must be avoided, because in this case, additional work would also need to be exerted against friction during the movement. Depending on the magnetic attraction force that is possible by means of the magnet actually used, an air-gap width must be chosen which allows, on the one hand, unimpeded movement of the acquisition unit by means of its movement device under optimal use of the electrical energy stored in the energy store, and at the same time ensures a reliable holding or attachment of the acquisition unit device to the preparation zone.

However, the magnetic holding or attachment device may also be integrated in the movement device, wherein, for example, leg-like structures, wheels, rollers or drums, balls, chains or belts contain suitable magnets or are made of magnets or magnetic materials.

When the acquisition unit is used for its intended purpose in the preparation zone, the permanent magnet holds the acquisition unit in a stable position against the preparation zone, while the movement device with the wheels can move the acquisition unit on the preparation zone.

Coordination of the holding or attachment device with the movement device can be used to achieve forms of embodiment with specific particularly advantageous properties. Elements which have a large contact surface, such as rollers, chains and belts can, in particular with holding or attachment device integrated in the movement device, induce strong contact forces, which allows a high load or a high dead weight of the acquisition unit. Spheres allow the acquisition unit to be moved in an agile manner. Wheels offer good contact while requiring little space and established drive systems.

As mentioned above, in principle different actuators can be used to drive the elements for transmitting power for movement, such as for driving the wheels or belts. It is advantageous if the movement device comprises at least one electric motor, but preferably two electric motors. Thus, when using an electric motor, the movement device may further comprise a steering device (similar to that of a car) in order to pivot at least two of the elements involved in the transmission of power, for example, at least two wheels together (in the same direction), so that cornering is possible. Preferably, however, the movement device comprises two electric motors, each of which is designed to actuate or move at least one element (such as a wheel) designed for power transmission. Thus, a change in direction of the movement of the acquisition unit can be achieved by changing the rotational speed of the two electric motors relative to each other or by rotating them in opposite directions. This is therefore a case of tank steering, which also allows turning when stationary.

In order to allow navigation of the acquisition unit in the product presentation device, the condition detected by the first sensor, or the data acquired by the first sensor can be used. However, data from other sensors can also be used as an alternative or as an addition.

It has therefore proved advantageous if the movement device of the acquisition unit comprises at least one second sensor which is provided for capturing the environment of the acquisition unit or the position of the acquisition unit for the purposes of moving the acquisition unit.

This second sensor can be a stand-alone sensor that is positioned independently of the position of the first sensor. The first sensor and the second sensor can also form a sensor unit together. Also, the first sensor may be designed to temporarily assume the task of the second sensor instead of acquiring the condition of the product presentation device or in addition to acquiring the condition of the product presentation device.

The second sensor may be the same type of sensor as the first sensor. For example, both can be designed as cameras. It can also be a different sensor type, of course. For example, the first sensor may be designed as a camera system, while the second sensor is designed to perform a time-of-flight measurement to capture the environment usable for the movement. A reverse configuration is also possible.

In summary, the second sensor can be designed, for example, as a camera, as a 3D camera system or as a sensor for carrying out a local time-of-flight measurement.

The second sensor can also be parts of a larger system, such as a positioning system, in particular an indoor positioning system (abbreviated to IPS). For example, the IPS may be a Wi-Fi positioning system (abbreviated to WPS) and (a) the second sensor may comprise a Wi-Fi module or be implemented as such, so that the position of the acquisition unit in the business premises in which the product presentation device is positioned can be determined by means of WPS.

Furthermore, RFID or NFC modules or objects, such as price display labels, which comprise an RFID or NFC module may be provided on the product presentation device. In order to use these modules for navigation or position determination, it has proved advantageous that the second sensor comprises an RFID or NFC unit. This allows the position of the acquisition unit within the product presentation device to be determined by means of the RFID or NFC modules installed there (and, if necessary, also in known positions) in their immediate vicinity. Conversely, the position of positionally unknown RFID or NFC modules in the product presentation device during the movement of the acquisition unit can also be determined by this combination of measures as soon as the acquisition unit is in close proximity to an RFID or NFC module positioned in the product presentation device and the position of the acquisition unit is known, because this position results, for example, from the path travelled (e.g. similar to a dead reckoning).

A plurality of second sensors can also be provided. Thus, one of the second sensors may be designed to perform an indoor localization, in particular to determine the position within the business premises, while a further second sensor may be designed as a camera to check the immediate vicinity of the acquisition unit for suitability for access, i.e. to determine whether objects are standing in the way or whether the end of the preparation zone, that is, the end of a travel region, has been reached and a change in direction is necessary as a result.

The acquisition unit may be designed to move completely autonomously through the presentation device or through multiple presentation devices and to store the acquired states in the form of acquisition data. These can be read out by an employee at regular intervals, for example, in order to determine, after the shop closing time, on the basis of the acquired conditions, where items are to be refilled or where other measures are necessary. In order to be able to react quickly to current conditions (possibly also changes in condition), but also to be able to further process the acquisition data externally from the acquisition unit, it is desirable to be able to provide this acquisition data automatically.

It has therefore proved advantageous that the acquisition unit comprises a first radio module, which is designed for radio-based communication of data, the data relating to the sensor and/or the movement device. Thus, the data relating to the sensor, in particular the acquisition data, but also, if appropriate, data relating to the condition of the sensor or the acquisition unit, such as the battery condition, can be transmitted directly to an external receiver or uploaded to a cloud-based service on the internet.

For this purpose, at least one second (external) radio module, designed for radio-based communication of data with the first radio module integrated into the acquisition unit, can be provided. For example, the second radio module can be an access point of a Wi-Fi infrastructure in a business premises. The data is transferred from there to an external processing unit, such as a server or to the cloud-based service, where the data can be further processed with appropriate computing power and storage availability. This measure makes it possible to process the data further outside the acquisition unit with significantly higher computing power, so that the sales staff can gain insight into the conditions of the product presentation devices as well as the conditions of the acquisition unit at a central location (e.g. in the back office of the store).

This reduces the amount of data that must be processed directly by the acquisition unit, which allows the computational power as well as the memory requirement to be designed at correspondingly lower cost. The acquisition unit can therefore be designed to be produced correspondingly more compact and thus also more cost-effectively.

Data processing (in particular pre-processing) in the acquisition unit itself has the advantages that the acquisition unit, even if the radio contact with its infrastructure is interrupted, can autonomously and dynamically continue its movement or navigation in the product presentation device, can continue to acquire the conditions, store the acquisition data thereby generated in compressed form and output it for further evaluation at a later time.

Therefore, according to a preferred embodiment the acquisition unit comprises a control unit, which is designed to control the movement device in such a way that the acquisition unit is maneuverable autonomously within the product presentation device. The internal control unit can be designed to autonomously manoeuvre the acquisition unit from one target position to the next in order to allow the most complete acquisition of the condition of the product presentation device possible. It may also be provided that the acquisition unit can be controlled remotely by means of the external processing unit.

As already mentioned, it has been shown to be advantageous that the at least one first sensor is designed to generate acquisition data, the acquisition data representing the acquired state of the product presentation device, and that the control unit is designed to process the acquisition data beforehand.

In this pre-processing of the acquisition data, the data can be interpreted and the data volume reduced. The control unit may be designed to transmit data by means of artificial intelligence (AI), pattern recognition, or machine learning. For example, the acquisition data can be reduced from extensive raw image data to the information indicating how many articles are located in the product presentation device or in a section of the product presentation device. Also, the acquisition data can be optimized only in terms of size, i.e. compressed.

The control unit may also be designed to transmit the data via the first radio module only if a critical quantity, which can be predefined, for example, or obtained from artificial learning processes, is undershot or exceeded during the acquisition of the condition. Thus, the control unit may be designed to transmit acquisition data when the occupancy of the product presentation device with products falls below a minimum quantity or when a certain temperature is exceeded in a certain region in the product presentation device, which data, in addition to the indication of the occurrence of this critical quantity, may also include an alarming data component.

The control unit may also be designed to transmit acquisition data at certain intervals or after successful acquisition of specific spatial regions.

Furthermore, the control unit may be designed to combine the aspects of the critical quantity, the time intervals or the spatial regions in order to generate a trigger for the transmission of the acquisition data.

In summary, the internal first radio module can thus be designed to deliver the acquisition data of the sensors as raw data or pre-processed data or also as other data that relate to the acquisition unit, for example via a wireless local area network (WLAN/WIFI) or via a mesh network configuration. Other (de-facto standardized) communication protocols such as ZigBee or Bluetooth can also be used. It may also be provided that the sensors are equipped with a 4G or 5G radio module to handle their radio traffic over a (public) mobile communication network and to act as IoT devices (IoT here stands for Internet of Things). A separate 4G- or 5G-capable radio device can also serve as an access point for the sensors that are connected to this access point via radio or by wires. Of course, other devices belonging to the infrastructure of an inventory control system, or a shelf rack logistics system can also serve as an IoT hub for the sensors. For this purpose, cameras can be used, for example, to film product presentation devices. These cameras have 4G or 5G mobile radio capability and communicate with the sensors or the acquisition unit by radio according to a different communication protocol.

For the radio-based connection of the sensors or the acquisition unit, of course, a proprietary communication method or communication protocol can also be used, as is known, for example, from PCT/EP2014/053376, the disclosure of which in regard to the time-slot communication method discussed therein is incorporated by reference. In contrast to the system disclosed in PCT/EP2014/053376, however, this time-slot communication method is used here for communication between a sensor access point and a group of sensors or acquisition units assigned to this sensor access point. This proprietary communication method allows an extremely energy-conserving operation of the battery-powered sensors or acquisition units, albeit at the expense of sensor availability. Against this background, the first radio module can only switch from its standby mode to its active mode very rarely in order to be available for radio communication. Even in this standby mode, the acquisition unit is able to perform one or more acquisitions and move around. The acquisition data generated in this way can then be delivered over time using the proprietary communication method as soon as the first radio module is in its active mode.

In order to ensure higher availability of the acquisition data, the first radio module may be equipped with an additional wake-up receiver so that it can be activated by a wake-up signal emitted (possibly also addressed) by a wake-up transmitter, in order to then deliver acquisition data in the active mode and then re-enter the energy-saving standby mode until it is required to be radio-available again according to the time frame of the proprietary communication method. The wake-up signal thus has the effect of an external trigger signal in order to put the first radio module into the active mode.

According to a preferred form of embodiment, the acquisition unit comprises a first detection stage which is designed to detect a loss of the autonomous holding or attachment of the acquisition unit on the product presentation device.

For this purpose, for example, the data of the at least one first sensor or the at least one second sensor can be evaluated. If, for example, a black image or a very small distance is detected between the sensor and the surface to be acquired or an object in general, this may indicate that the autonomous holding or attachment of the acquisition unit has been lost. It is also possible to detect the torque that the drive element of the movement device must overcome. If the movement device comprises, for example, an electric motor and wheels and if, after the loss of autonomous holding or attachment of the acquisition unit, the wheels are located in the air without contact with the product presentation device, this can be detected by monitoring the behaviour of the wheels or the driving electric motor. However, additional sensors may also be provided to detect a loss of autonomous holding or attachment of the acquisition unit. For this purpose, for example, contact sensors may be provided on the wheels or on the alternative elements for locomotion discussed. In the event of loss of contact between the wheels and the preparation zone, such contacts generate a signal that can be processed by the detection stage. If a magnetic holding or attachment device is used, the behaviour of the magnetic field can also be detected, for example using a Hall sensor. If the autonomous holding or attachment of the acquisition unit is lost, the magnetic field changes due to the magnet no longer being located close to the preparation zone, which provides a signal that can be processed by the detection stage. The detection stage can be a stand-alone unit or be designed as part of the control unit. It can be implemented based on hardware and/or software.

The loss of the autonomous holding or attachment of the acquisition unit may be due to several reasons. This can happen, for example, if the acquisition unit device undergoes a shock, for example, if someone pushes a shopping cart against the product presentation device, or in the event of attempted theft of the acquisition unit, i.e. if it is deliberately removed from the preparation zone. In any case, it is advantageous for the sales staff to be informed of the fact of the loss of attachment.

Therefore, the acquisition unit is preferably designed to be automatically informed of any loss of autonomous holding or attachment, and in particular about the current position of the acquisition unit. In this context, it may be advantageous if the acquisition unit is designed to perform at least one of the following actions in the event of loss of the autonomous holding or attachment:
to emit an acoustic signal via an acoustic signal module of the acquisition unit,
to emit an optical signal via an optical signal module of the acquisition unit,
to transfer acquisition data of the at least one first sensor and/or of the at least one second sensor immediately upon occurrence of the loss of holding or attachment,
to transfer informative data which describes or indicates a discrepancy with regard to the holding or attachment behaviour,
to control the movement device in such a way that, for example, a rocking movement of the acquisition unit is caused or that the movement device causes an attention-attracting acoustic signal,
to carry out an acquisition with the first sensor at time intervals and to transfer the acquisition data in order to enable conclusions to be drawn as to the situation or position of the acquisition unit,
to cause the acquisition unit to enter an energy-saving state if the acquisition unit is not replaced on the product presentation device within a certain time.

The detection of a loss of the autonomous holding or attachment can also take place wholly or partly or additionally externally. For this purpose, a second detection stage external to the acquisition unit can be provided, in particular implemented as a component of the external processing unit, which is designed to detect a loss of autonomous holding or attachment of the acquisition unit on the product presentation device, wherein for this type of detection the transferred acquisition data or the data from the second sensor are used.

The product presentation device can be designed such that the preparation zone on which the acquisition unit moves is also designed for the presentation of products, which implies, however, that the acquisition unit must be moved between the products.

However, according to a preferred form of embodiment, the product presentation device comprises, in addition to the at least one preparation zone provided for the movement of the acquisition unit, a product presentation zone distinct from the preparation zone for the purpose of presenting products. This measure avoids the risk of collision between the acquisition unit and articles located in the product presentation zone for presentation purposes. At the same time, this separation of the zones ensures a relaxed, undisturbed shopping experience for customers, because they are not distracted by the moving acquisition unit.

Preferably, the product presentation device comprises at least one shelf, wherein the preparation zone is formed at least partially from a side of a rear wall facing toward the product presentation zone or also a side wall of the shelf and/or a ceiling of the shelf. This allows for a simple yet clear separation of the zones and movement of the acquisition unit in zones where it is certain that no products are presented.

The product presentation device may comprise a single preparation zone, which the acquisition unit can travel over. However, according to a preferred form of embodiment, at least two differently oriented preparation zones are provided in the product presentation device, which are connected to each other with a transition element, wherein the transition element is designed in such a way that a translation from the one preparation zone to the other preparation zone is enabled or can be carried out by means of the movement device, in fact without loss of holding or attachment occurring. Such a transition element can be a curved transition profile, which allows the translation from a (substantially flat) planar preparation zone to another (substantially flat) planar preparation zone. However, the transition element can also be a bridge or a web, which allows the crossing of structural elements, for example, the crossing of columns or shelf floor ends between two preparation zones or intermediate gaps. However, the transition element may also be a tunnel passing through a support of the product presentation device or through plate-shaped boundary elements.

Such a transition element can also connect multiple product presentation devices to one another. Additional preparation zones may also be provided outside the product presentation device. For example, preparation zones may be provided on the ceiling and the inner wall of the store premises, which are connected via transition elements to the preparation zones within the product presentation devices, so that the acquisition unit can translate between different product presentation devices via these paths.

This is true even if the acquisition unit is designed to travel along preparation zones even against the force of gravity. It should also be noted that the acquisition unit may be designed to travel on the floor of a store premises also. Thus, for example, in the daytime the acquisition unit can travel autonomously in a product presentation device or a group of product presentation devices connected to each other by means of transition elements and there acquire the conditions of the product presentation device or product presentation devices. After close of business, the acquisition unit can travel across the floor of the store to the nearest product presentation devices or to the nearest group of product presentation devices, in order to acquire the conditions of the product presentation device or product presentation devices there, for example during the night hours, but in particular during the next business day.

The acquisition unit may also comprise a display screen. This screen may be designed to display different types of information regarding the acquisition data or the acquisition unit. For example, the screen may be designed to display the battery level of the energy store of the acquisition unit. Preferably, the screen is designed to display a unique identification number of the acquisition unit. This allows for simple handling when using multiple such acquisition units.

Finally, it should be mentioned that the electronic devices mentioned naturally comprise electronics. The electronics can be either discrete or built using integrated electronics or a combination of the two. Microcomputers, microcontrollers, application specific integrated circuits (ASICs) can also be used, possibly in combination with analogue or digital electronic peripheral components. The functions of the electronic devices discussed are implemented with the aid of the hardware components mentioned, possibly in combination with software that is executed on the programmable components. Radio units typically comprise an antenna configuration as part of a transceiver module, including a matching network, etc. for sending and receiving radio signals.

The sensor is preferably battery-powered.

In summary, the measures mentioned form a system for acquiring a condition of a product presentation device.

These and other aspects of the invention are obtained from the figures discussed below.

### BRIEF DESCRIPTION OF THE FIGURES

The invention is again explained below with reference to the attached figures and on the basis of exemplary embodiments, which nevertheless do not limit the scope of the invention. In the different figures the same components are labelled with identical reference numbers. They show in schematic fashion:

FIG. 1 an acquisition unit according to a first exemplary embodiment,

FIG. 2 the acquisition unit according to FIG. 1 in a further view,

FIG. 3 a second exemplary embodiment of the acquisition unit,

FIG. 4 a side view of the acquisition unit self-attaching to a preparation zone,

FIG. 5 the acquisition unit according to FIG. 4 as viewed from the preparation zone,

FIG. 6 a block diagram of the acquisition unit according to the second exemplary embodiment,

FIG. 7 a product presentation device as viewed from a first perspective, in which the acquisition unit is visible,

FIG. 8 the product presentation device as viewed from a second perspective, in which the acquisition unit is not visible.

### DESCRIPTION OF THE EXEMPLARY EMBODIMENTS

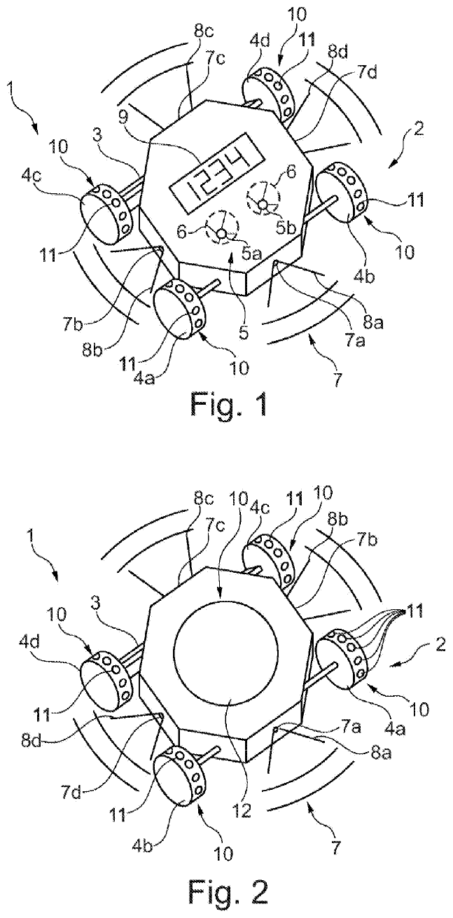

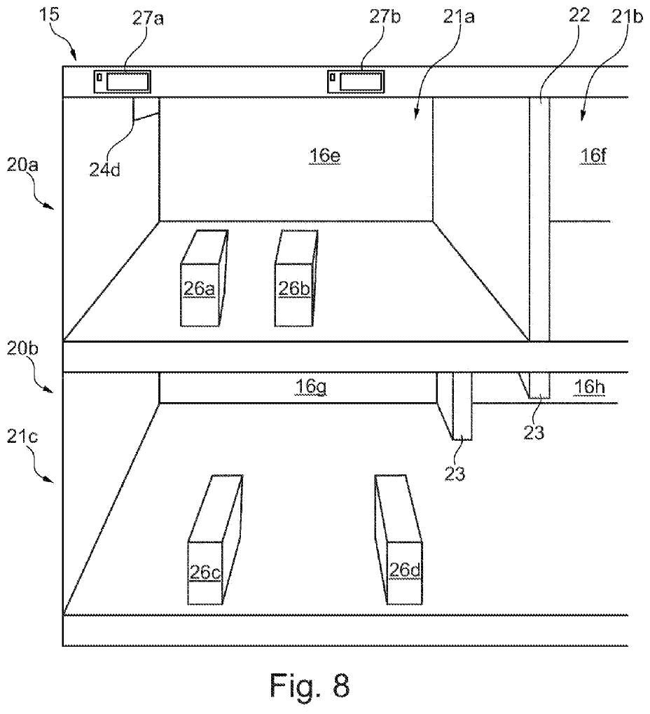

FIG. 1 shows a first exemplary embodiment of an acquisition unit 1 realized as a miniature vehicle, which is designed for acquiring conditions of a product presentation device, such as, for example, the occupancy state of a shelf rack 15 with products 26a to 26d (see e.g. FIG. 8). FIG. 1 shows the underside of the acquisition unit 1. The acquisition unit 1 comprises a movement device 2, which comprises a steering device 3 and an electric motor 31a, which is located inside the acquisition unit 1 and is therefore not shown. The movement device 2 further comprises four wheels 4a, 4b, 4c and 4d. The electric motor 31a in this exemplary embodiment is designed to jointly drive two wheels 4a and 4b, which are positioned along an axle. The steering device 3 is designed to pivot the other two wheels 4c and 4d jointly in the same direction to enable cornering. For this purpose, the steering device 3, in addition to the mechanical components, comprises a stepper motor located in the interior of the acquisition unit 1 and therefore not visible, to pivot the wheels 4c and 4d to the desired position.

The acquisition unit 1 further comprises a first sensor 5, which comprises two sensor components, namely a transmitter 5a and a receiver 5b. These externally visible sensor components are used by the sensor 5 to carry out a distance measurement by means of time-of-flight measurement of a signal transmitted by the transmitter 5a, wherein the signal is received by the receiver 5b after reflection on an object and the time-of-flight is obtained as a time difference between the transmission and reception. The first sensor 5 detects objects within an acquisition range 6 (only roughly indicated in FIG. 1), which opens in a substantially funnel-shaped manner away from the acquisition unit 1.

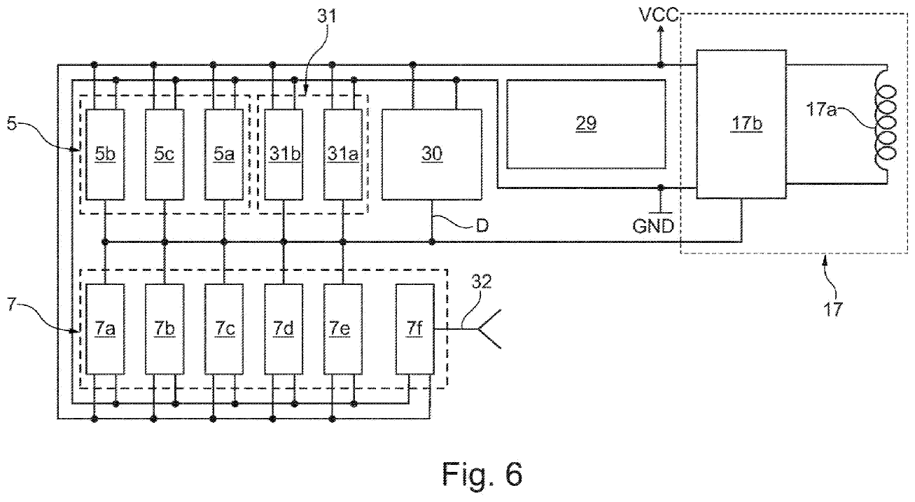

The acquisition unit 1 further comprises a second sensor 7 which comprises four second sensor units or sensor elements 7a-7d. Each of these second sensor units 7a-7d captures the environment adjacent to the respective side of the acquisition unit 1 within a respective second acquisition range 8a-8d. In this exemplary embodiment, the second sensor units 7a-7d are also designed—i.e. as before in the context of the first sensor 5—for carrying out a distance measurement by means of time-of-flight measurement. Furthermore, the second sensor 7 comprises an NFC module 7e and a Wi-Fi module 7f, both of which are located in the interior of the acquisition unit 1 (see also FIG. 6.), which are respectively provided or used for carrying out an indoor localization, which is discussed in detail below.

The acquisition unit 1 comprises a display screen 9. This display screen 9 displays an individual identification number, which allows a unique determination or identification of the acquisition unit 1.

The acquisition unit 1 further comprises the Wi-Fi module 7f as a first radio module for sending and receiving data (see also FIG. 6).

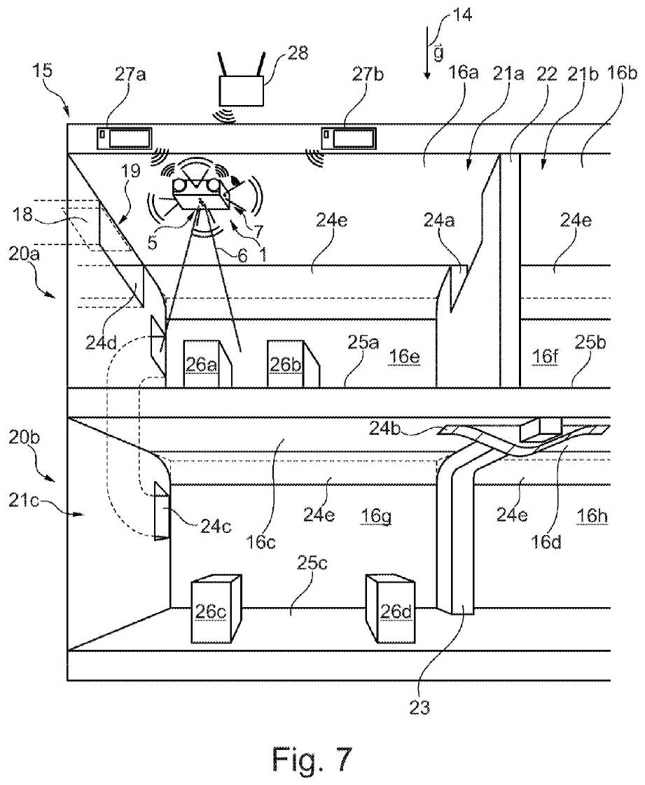

Referring to FIG. 6, it is noted that the NFC module 7e, the Wi-Fi module 7f, the steering device 3 and the electric motor 31a of the movement device 2 are connected to a control unit 30. The control unit 30 is designed to process and interpret the data of the NFC module 7e, the first radio module 31, the first sensor 5 and the second sensor 7. On the basis of this information, the control unit 30 can autonomously decide which areas of the shelf rack 15 (see FIG. 7) must be visited in order to carry out the most complete acquisition of product presentation zones, specifically shelf bases 25a-25c, with the products 26a to 26d placed on them, and in doing so actuate the steering device 3 and the electric motor 31a appropriately in order to move or manoeuvre the acquisition unit 1 accordingly.

The acquisition unit 1 comprises a magnetic holding or attachment device 10 as a holding or attachment device. This magnetic holding or attachment device is particularly apparent in FIG. 2, which shows the top of the acquisition unit 1.

If the acquisition unit 1 is deployed as intended in a shelf rack 15, the top is positioned adjacent to a preparation zone along which the acquisition unit 1 moves and the underside faces a product presentation zone, the condition of which is to be acquired.

In FIG. 2, therefore, one can see the side of the acquisition unit 1 that is directly adjacent to the surface on which the acquisition unit 1 travels or moves when used for its intended purpose. In the present case, the holding or attachment device 10 comprises a plurality of magnets, each of which is located in one of the wheels 4a-4d and are therefore referred to as wheel magnets 11 in the interests of distinguishability. For the sake of clarity these are only completely labelled with reference signs in FIG. 2 for one of the wheels 4a. However, it should be noted that each of the wheels 4a-4d comprises multiple wheel magnets 11 distributed equidistantly along the circumference. In the present case, the holding or attachment device 10 additionally comprises a central magnet 12, which is placed in the middle of the top of the acquisition unit 1 spaced equidistantly from the four wheels 4a-4d. The acquisition unit 1, which is thus equipped with the magnets 11 and 12, can move itself in a self-holding or self-attaching manner on a shelf rack structure made of a ferromagnetic material, such as the underside of a shelf floor made of sheet steel or a rear or side wall of the shelf rack 15. The magnets 11 and 12 hold the acquisition unit 1 by the attracting magnetic force generated by them on the respective shelf structure, but without impacting the free or autonomous mobility of the acquisition unit 1.

For the sake of completeness, it should be noted that the acquisition unit 1 can of course be equipped with the wheel magnets 11 only or with the centre magnet 12 only.

In the form of embodiment in which the wheel magnets 11 are provided, and the wheels 4a-4d as viewed from any side form the outermost points of the acquisition unit 1, the advantage is obtained that the acquisition unit 1 can carry out by itself an ascent to the shelf structure made of sheet steel, for example starting from the floor of a store premises, because the wheels 4a to 4d can directly transmit magnetic forces and thus adhere to the steel sheet. This may be important, for example, if the acquisition unit 1 comes to rest on the floor of the store after loss of the attachment or holding position, for example after an intentional or unintentional removal of the acquisition unit 1 from the shelf rack.

If the acquisition unit 1 is found to come to rest with the top side facing upwards, it can travel firstly to a non-magnetizable structure, such as a concrete wall, right itself there at the wall by friction of the wheel pairs 4a, 4b and 4c, 4d and subsequently tip over backwards so that the top is now oriented downwards. In this orientation, the acquisition unit 1 can now move to a shelf rack 15 again and there move into the shelf structure in a self-attaching manner, so that during the movement the top is aligned just adjacent to the structure of the shelf rack.

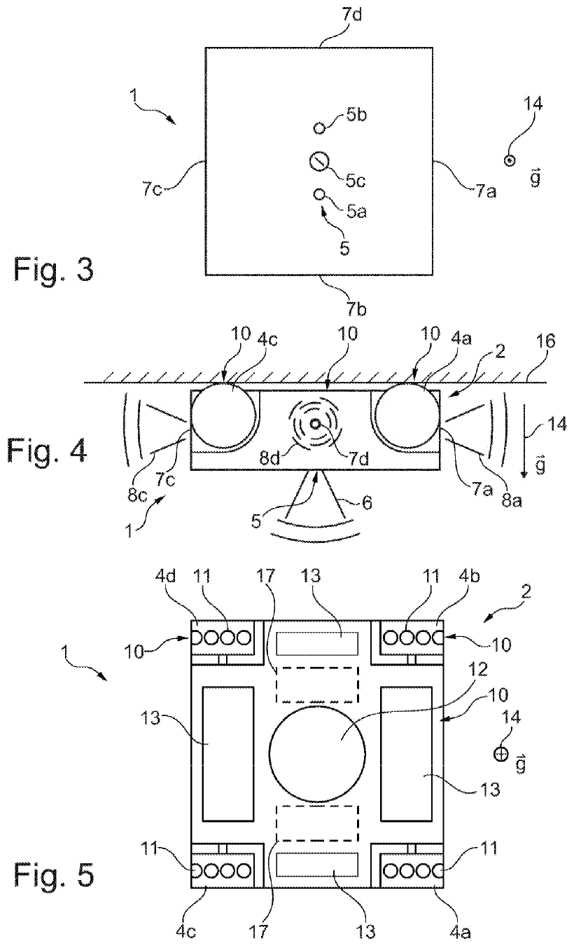

FIGS. 3 to 5 show a second exemplary embodiment of the acquisition unit 1. In contrast to the first exemplary embodiment discussed above, this does not comprise a steering device 3. In the present case, the acquisition unit 1 comprises a second electric motor 31b, which, like the first electric motor 31a, is located inside the acquisition unit 1 and is therefore not visible (see also FIG. 6). Each electric motor 31a and 31b drives one wheel 4a, 4b, wherein the two driven wheels 4a, 4b are positioned along an axis. For cornering, these wheels 4a, 4b can be moved at different rotation speeds. Thus this is a type of tank steering. Alternatively, four electric motors could also be provided, each electric motor driving a wheel 4a-4b, or two electric motors could be provided, with one electric motor then driving the wheels 4a and 4c on one side of the acquisition unit 1 and the other electric motor then driving the other wheels 4b and 4d on the other side of the acquisition unit 1.

FIG. 3 shows the underside of the acquisition unit 1 with a view of the sensor 5. In addition to the two sensor units 5a and 5b, which are designed for carrying out a time-of-flight measurement, the sensor 5 also comprises a camera 5c. This allows the acquisition activity to be performed using two different technologies and, if appropriate, a subsequent comparison of the separately obtained acquisition results in order to arrive at a consolidated result.

In this exemplary embodiment, the acquisition unit 1 also comprises the second sensor 7, which here also comprises four second sensor units 7a-7d and an NFC module 7e and a Wi-Fi module 7f. The four second sensor units 7a-7d are designed here as cameras.

As also in the exemplary embodiment discussed above, the acquisition unit 1 here also comprises the control unit 30, wherein here also the control unit 30 is designed to actuate both electric motors 31a and 31b in such a way that the acquisition unit 1 is autonomously maneuverable.

Furthermore, in FIGS. 3 to 5, the acceleration due to gravity 14 is indicated in order to illustrate the orientation of the acquisition unit 1 during its intended use in a shelf rack on the underside of a shelf floor (i.e. on the ceiling of a shelf level). However, it should also be noted that the acquisition unit 1 can also travel along a vertical wall, in which case the acquisition unit 1 is oriented correspondingly differently to the acceleration due to gravity 14.

In FIG. 4, the acquisition unit 1 is shown in a side view, wherein it is held autonomously by means of its magnetic holding or attachment device 10 “upside down” on a preparation zone 16 (in the specific case of the underside of a shelf floor) of a shelf rack 15. In this view, the acquisition range 6 is also indicated, wherein this acquisition range 6 starting from the sensor 5 substantially away from the preparation zone 16 is aligned to the region of the product presentation device 15 below it, so that the condition of this region can be acquired by the sensor 5. Also shown in this view are the acquisition ranges 8a, 8c and 8d of the second sensor units 7a, 7c and 7d, which substantially enable acquisition along the preparation zone 16, thus substantially in the plane of motion of the acquisition unit 1.

In FIG. 4, the contact point of the two wheels 4a and 4c is also apparent, where the wheels 4a and 4c touch the preparation zone 16.

In FIG. 5, the acquisition unit 1 is shown as viewed from the preparation zone 16 onto the acquisition unit 1, that is, onto the top of the acquisition unit 1. This representation enables a view of the holding or attachment device 10, which is also implemented here as a magnetic holding or magnetic attachment device. In the present case, also, the holding or attachment device 10 comprises a plurality of wheel magnets 11 in each wheel 4a-4d, as well as the centre magnet 12. In addition, in the present case, the holding or attachment device 10 comprises four edge magnets 13, which are placed substantially along the edge of the acquisition unit 1 between the positions of the wheels 4a to 4d or extend between them. The edge magnets 13 may be provided to further amplify the magnetic attraction force.

It is also possible to dispense with one or more of these magnets 11, 12, 13 or to choose a different placement of these magnets 11, 12, 13, provided the holding or attachment of the acquisition unit 1 to the preparation zone 16 is ensured.

With regard to the wheels 4a to 4d, it should also be generally mentioned that, regardless of whether they are equipped with wheel magnets 13 or not, they are preferably made of a soft plastic in order to avoid causing rolling noise as far as possible. If the wheels are equipped with wheel magnets, it may be advantageous that these wheel magnets are fastened in such a way that a small air gap always remains between the respective wheel magnet and the shelving structure interacting with the respective wheel, in order to enable them to roll off substantially without noise. The same also applies in general to other measures (chains, balls, etc.) that are used to move the acquisition unit 1, in particular to allow it to interact directly with the shelf rack structure, and to which magnets are attached.

Furthermore, the acquisition unit 1 comprises a charging device 17 (see FIGS. 5 and 6), which is provided and designed for inductively charging a rechargeable energy store (see FIG. 6) of the acquisition unit 1.

FIG. 6 shows an electronic block diagram of the acquisition unit 1 according to the exemplary embodiment of FIGS. 3 to 5. The mechanical components, in particular the movement device 2, have been deliberately omitted from the drawing. However, it goes without saying that the wheels can be driven either directly by the electric motors or via a gearbox. A more complex suspension, e.g. including springs or shock absorbers, etc., can also be provided.

The charging device 17 of the acquisition unit 1 comprises a coil 17a and a rectification and voltage regulation unit 17b, optionally also a charge regulator unit, and an electrical energy store 29 connected to it. The charging device 17 is therefore designed to charge the energy store 29 by means of components 17a and 17b, if this is necessary.

The energy store 29 supplies all other components with electrical power and provides an operating voltage VCC with respect to a reference potential GND.

The control unit 30 is connected via a data signal bus to other components, which are discussed further below, and can exchange data and/or signals D with these components.

The movement device 2 comprises a movement device electronics 31, which comprises the first electric motor 31a and the second electric motor 31b and a power electronics unit, not illustrated in detail, for controlling the electric motors 31a and 31b. The movement device electronics 31 is controlled by means of the control unit 30 and thus the number of revolutions, optionally also the direction of rotation, of the electric motors 31a and 31b can be individually set.

The first sensor 5, specifically the two sensor units 5a and 5b as well as the camera 5c, deliver their data D, here acquisition data, via the data signal bus to the control unit 30, where these are (optionally pre-) processed. The control unit 30 can also influence or control the functions of the first sensor 5 via the data signal bus, such as the width of the acquisition range 6, optionally also the focus and/or orientation of the acquisition range 6.

Furthermore, the second sensor 7, specifically its sensor units 7a-7d as well as the NFC module 7e and also the Wi-Fi module 7f, is connected via the data signal bus to the control unit 30, so that these components can be controlled by the control device 30 and in particular exchange data D with it, which can represent, for example, control commands or sensor and/or communication data. Thus, the sensor 7 can be activated in order to carry out the acquisition and to (optionally pre-)process the data D thereby generated, here acquisition data, and then deliver it via the Wi-Fi module 7f, receive and process the identification data D via the NFC module 7e or even handle the radio activities via the Wi-Fi module 7f.

The Wi-Fi module 7f also comprises an antenna 32 in addition to the normally provided electronic circuits for modulation as well as demodulation, which are not shown in detail. With regard to the NFC module 7e, it should be mentioned that for reasons of clarity, the usual circuit-related details have been omitted. Of course, the sensor 7 can also comprise only the components 7a-7d, and the NFC module 7e and the Wi-Fi module 7f are implemented separately from it.

It should be mentioned that the Wi-Fi module 7f can be functionally assigned to the second sensor 7, and therefore according to this exemplary embodiment it can also be structurally integrated there. Therefore, the second sensor 7 can also access the Wi-Fi module 7f and transmit its acquisition data D autonomously by radio, even without the intervention of the control unit 30.

It should also be mentioned that the functionality of the autonomous movement can also be realized without the control unit 30 accessing the Wi-Fi module 7f. The acquisition unit 1 then moves autonomously, controlled by the control unit 30, while independently of this, the acquisition of the condition or conditions of the presentation device is carried out by the first sensor 7f, which delivers its acquisition data D by means of the Wi-Fi module 7f.

However, if the control unit 30 is coupled to the Wi-Fi module 7f via the data signal bus, the acquisition unit 1 can also be remotely controlled by radio. In this case, internal device parameters, such as the state of charge of the energy store or also internal acquisition data D relating to the movement device 2, can be retrieved externally by radio. Based on this, for example, a charging stop can be scheduled in good time or the acquisition unit 1 can be submitted to a maintenance of the movement device 2 in a timely manner. In addition, potential sources of error detected in the acquisition unit 1 autonomously by the (pre-)processing of the acquisition data D, such as contamination of the external elements of the first sensor 7, can therefore be communicated to an entity controlling the acquisition unit 1 (e.g. the server or the cloud-based management software) and there, depending on the severity of the problem detected, further measures can be automatically derived and the acquisition unit 1 actuated accordingly. For example, the acquisition unit 1 can be immediately removed from service if the acquisition data D supplied by the first sensor 7 are classified as potentially unusable. The acquisition unit 1 can then be moved to a service station without further transmission of acquisition data D, while, for example, at the same time a further acquisition unit 1 is started up, which takes over the acquisition tasks of the acquisition unit 1 to be serviced. The acquisition unit 1 can also be stopped immediately if a potential problem occurs with the movement device 2, in which case the acquisition unit 1 outputs its approximate position (e.g. known by mapping its own movement) by radio, so that it can be more easily located by the service personnel.

The control unit 30 further comprises a detection stage that interprets the data D and detects a loss of holding or attachment, as described in the general part of the description.

At this point it should also be noted that the acquisition unit 1 according to the exemplary embodiment shown in FIGS. 1 and 2 is similarly constructed, wherein instead of the second electric motor 31b, the stepper motor of the steering device 3 is provided to allow a change in direction, and the camera 5c of the first sensor 5 is omitted.

FIG. 7 shows a section of the product presentation device formed as the shelf rack 15, the shelf rack 15 being viewed from a rather unusual perspective for customers of a store, at an angle from bottom to top. In the shelf rack 15, the acquisition unit 1 is located according to the exemplary embodiment of FIGS. 3 to 5. Sections of two shelves of the shelf rack 15 are shown, namely an upper shelf 20a and a lower shelf 20b. The upper shelf 20a is divided into two shelf rack sections, the left shelf rack section 21a and the right shelf rack section 21b, with the two shelf rack sections 21a and 21b separated by a partition wall 22. The second shelf 20b has only one lower shelf rack section 21c in which a support 23 is located.

Each shelf rack section 21a to 21c comprises a product presentation zone 25a to 25c for presenting products 26a to 26d. The product presentation zones 25a to 25c are designed with flat surfaces and allow the products 26a to 26d to be placed on the product presentation zone 25a to 25c in order to present them.

The shelf rack 15 comprises multiple preparation zones 16a to 16h. The preparation zones 16a to 16h consist of a first group of preparation zones 16a to 16d, which is formed by the upper ceiling of the respective shelf 20a. 20b, and a second group of preparation zones 16e to 16h, formed from the side of the rear walls of the respective shelves 20a and 20b of the shelf rack 15 that face toward the product presentation zone 25a to 25c. The preparation zones 16a to 16h therefore differ from the product presentation zones 25a to 25c. The preparation zones 16a to 16h are not used for placing products 26a to 26d for presentation. Rather, the preparation zones 16a to 16h are used for transporting the acquisition unit 1 within the shelf rack 15.

In order to also enable continuous transport access to the individual preparation zones 16a to 16e, the shelf rack 15 comprises multiple transition elements which connect the preparation zones 16a-16h to one another to allow the acquisition unit 1 to pass over them in a self-holding manner. The transition elements are designed in terms of shape and materials such that the acquisition unit 1 can pass over them in such a way that the self-attaching or self-holding action of the acquisition unit 1 is maintained when translating between the preparation zones 16a to 16c.

As transition elements, for example, curved transition profiles 24e are shown here, each of which connect a preparation zone 16a to 16d of the first group to a preparation zone 16e to 16h of the second group.

A further transition element is formed as a bridge 24b and connects the two preparation zones 16c and 16d of the lower shelf 20b belonging to the first group. The bridge 24b allows the acquisition unit 1 to negotiate the support 23.

The left-hand rack section 21a and the right-hand rack section 21b are connected to each other by a further transition element, specifically by a first tunnel 24a, which tunnels through the partition wall 22 so that the acquisition unit 1 can move back and forth between the two preparation zones 16a and 16b of the first group of the upper shelf 20a. In this case, it is the tunnel floor of tunnel 24a running between the preparation zones 16a and 16b that forms the transition element which can be passed over by the acquisition unit 1. The same applies also in the case of a separation of a shelf floor by so-called shelf dividers, which separate the product groups on a shelf floor, wherein the acquisition unit 1 above the shelf divider can switch back and forth between the product groups while suspended upside down from the underside of the next higher shelf floor.

The preparation zones 16e and 16g of the second group of the left-hand shelf rack section 21a and the lower shelf rack section 21c are connected to each other via a path 24c, which here is essentially in the shape of an arc, so that the acquisition unit 1 can travel back and forth between the upper shelf 20a and the lower shelf 20b.

Furthermore, the shelf rack 15 comprises a second tunnel 24d with a tunnel floor acting as a transition element passable by the acquisition unit 1, which connects the shelf 15 to further, adjacent shelf racks and/or a maintenance space, or makes these passable for the acquisition unit 1.

At the beginning of this second tunnel 24d an energy supply zone 19 is located on the tunnel floor, which comprises a charging station 18. The acquisition unit 1 is designed to travel to the energy supply zone 19 in a timely manner when it requires energy and to place itself in relation to the charging station 18 in such a way that the charging station 18 can supply the charging device 17 of the acquisition unit 1 with energy by inductive means. The inductively transmitted energy is stored in the energy store 29 of the acquisition unit 1. The charging station 18 itself draws its energy from a rechargeable battery, possibly also a replaceable battery, the capacity of which is sufficient for multiple charging cycles of the acquisition unit 1. Alternatively, the charging station 18 can also be supplied with power by cable. At this point it should also be mentioned that the charging station 18 can of course also be located at any other position, such as within the boundaries of the preparation zones 16a to 16h, in order to be as easy as possible to locate and approach.

The transition elements are curved and/or flat and made of magnetic material, such as the same material as the preparation zones 16a to 16h, in particular, for example, sheet steel, so that the acquisition unit 1 also attaches there magnetically when moving.

On the front edges of the shelf floors, NFC-enabled electronic shelf labels 27a and 27b are placed on the shelf rack 15. In order not to overload the drawing, only two such shelf labels have been illustrated, wherein such a shelf rack would usually contain many more, in particular corresponding to the positions of the associated products. These shelf labels 27a and 27b display product and/or price information at their respective positions and are designed to deliver identification data to the acquisition unit 1 by means of their NFC electronics when the unit is in their immediate vicinity. Because the positions of the shelf labels 27a and 27b in the store are stored accurately in a planogram, this identification data allows precise position determination for the acquisition unit 1. For this purpose, the transmitted identification data is transmitted by radio from the acquisition unit 1 to a server, where the data of the planogram is also available, and on the basis of the identification data arriving at the server, the current position of the acquisition unit 1 is determined.

Outside the shelf rack 15, in the store premises in which a plurality of such shelf racks 15 are located, multiple access points 28 are distributed in the store premises, only one of which is drawn in FIG. 7 for reasons of clarity. These access points 28 allow radio communication of the acquisition unit 1 with a processing unit (the server), optionally also a Wi-Fi-based location of the acquisition unit 1 in the store premises. The access points 28 may also be designed for communication according to the communication methods or protocols disclosed in the general part of the description in order to communicate with electronic shelf labels 27a and 27b.

By means of the control unit 30, which is based on software executed on a processor, and which uses the data D of the sensors (predominantly of the second sensor units 7a-7d), the acquisition unit 1 can move or manoeuvre autonomously in the respective preparation zones 16a to 16h, translate between the individual preparation zones 16a to 16h, i.e. between the individual shelf rack sections 21a to 21c, as well as between the shelves 20a and 20b and even between the individual shelf racks 1. In this case, it is entirely sufficient that the navigation software moves the acquisition unit 1 in a similar way to a conventional autonomously travelling lawn mower, i.e. does not have such a high navigation performance as is necessary for autonomous navigation in road traffic, but instead is designed to enable the acquisition unit 1 to move with sufficient track density corresponding to the region to be acquired in the respective shelf rack 1. The control unit detects obstacles such as travel lane boundaries, then changes the direction of travel and continues the movement, etc. In doing so it can map the movement zones, store them and use them again later for navigation, in particular in order to move to the charging station 18 quickly if necessary or to switch between the preparation zones 16a to 16d on the transition elements provided for this purpose.

This allows the acquisition unit 1 to move the acquisition range 6 of its first sensor 5 through the entire shelf rack 15 (or even through multiple shelf racks 15) and thus to acquire the condition, such as the occupancy and/or distribution of the products, of the entire shelf rack 15. The condition in this exemplary embodiment relates in particular to the occupancy, i.e. whether and which products 26a to 26d are placed where on the shelf rack 15 and, optionally, what the condition of these products is, i.e. whether damage (e.g. to the packaging, such as pressure damage, tears or even breakage marks) is visible, or whether the expiration date has already been exceeded. For this purpose, the control unit 30 is designed to perform image processing with pattern recognition. In addition, the first sensor 5 could of course comprise further sensor units in order to acquire further quantities, such as the temperature or humidity at the point of acquisition, i.e. in the neighbourhood, predominantly above the products.

For targeted navigation in the shelf rack 15, the acquisition unit 1 uses, as already mentioned, in particular the data of the second sensor 7 (in addition to data of the first sensor 5, if applicable). Here, for example, the image or video data of the second sensor units 7a-7d is available. However, the identification data of the electronic shelf labels 27a, 27b and the location via the access points 28 can also be used for navigation. Of course, targeted navigation is also possible if individual components of the second sensor 7 are omitted, or if only the data of the first sensor 5 is used. In particular, the use of multiple different position determination methods allows navigation as accurately as possible outside of the shelf racks 15, e.g. between the shelf racks 15 or even when moving throughout the store. In this way, a Wi-Fi-based location can provide information about the shelf 15 in which the acquisition unit 1 is currently located and which shelves 15, which have not yet been acquired, are in the vicinity and still need to be approached in order to carry out the acquisition of the respective condition there also. At the same time, the NFC-based location can precisely determine in which shelf 20a, 20b and in which shelf rack section 21a to 21c, in particular adjacent to which electronic shelf labels 27a or 27b, the acquisition unit 1 is currently located. An image-based and/or distance-based acquisition of the environment is particularly advantageous to precisely manoeuvre locally, such as when systematically leaving the preparation zone 16a to 16d or when moving along the transition elements.

Finally, in FIG. 8, the shelf rack 15 is viewed from a perspective that corresponds to the natural viewing perspective of an average customer, that is, looking into the shelves 20a and 20b slightly obliquely from above. It can be clearly seen here that the acquisition unit 1 and most of the transition elements 24a-24e are not visible from this perspective. In addition, the view of the presented products 26a to 26d remains clear even in the presence of the acquisition unit 1 and above all, unhindered by the acquisition unit 1, since in normal usage the acquisition unit 1 predominantly moves on the underside of the shelves or along the rear wall, optionally also along the side wall, of a shelf. This allows customers to shop and review the presented products 26a to 26d undisturbed, even if the acquisition unit 1 is currently maneuvering through the shelf rack 1 (or through the shelf racks) and carrying out acquisition tasks.

To conclude it will once again be pointed out that the Figures described in detail above are merely exemplary embodiments, which can be modified in a wide variety of ways by the person skilled in the art without departing from the scope of the invention. For the sake of completeness, it is also pointed out that the use of the indefinite article “a” or “an” does not exclude such features from also being present more than once.

1. Acquisition unit (1), comprising:
at least one first sensor (5), which is provided for acquiring a condition of a product presentation device (15), and
a movement device (2), which is designed for self-propelled movement of the acquisition unit (1) within the product presentation device (15), and
a holding or attachment device (10), which is implemented within the product presentation device (15) for automatically holding or attaching the acquisition unit (1) to the product presentation device (15) at the respective location of movement.

2. Acquisition unit (1) according to claim 1, wherein the holding or attachment device (10) is implemented by means of a magnetic holding or attachment device.

3. Acquisition unit (1) according to claim 1, wherein the movement device (2) comprises at least one element from those listed below, namely:
wheel (4a-4b),
roller,
chain,
belt,
ball.

4. Acquisition unit (1) according to claim 1, wherein the movement device (2) comprises at least one electric motor (31a), but preferably two electric motors (31a, 31b).

5. Acquisition unit (1) according to claim 1, wherein the movement device (2) comprises at least one second sensor (7) which is provided for capturing the environment of the acquisition unit (1) or the position of the acquisition unit (1) for the purposes of moving the acquisition unit (1).

6. Acquisition unit (1) according to claim 1, which comprises a first radio module (7f) which is designed for radio-based communication of data (D), wherein the data (D) relates to the sensor (5, 7) or the movement device (2).

7. Acquisition unit (1) according to claim 1, which comprises a control unit (30) which is designed to control the movement device (2) in such a way that the acquisition unit (1) is maneuverable autonomously within the product presentation device (15).

8. Acquisition unit (1) according to claim 6, wherein at least the at least one first sensor (5) is designed to generate acquisition data (D), wherein the acquisition data (D) represents the acquired condition of the product presentation device (15), and wherein the control unit (30) is designed to pre-process the acquisition data (D).

9. Acquisition unit (1) according to claim 1, which comprises a first detection stage designed to detect a loss of the autonomous holding or attachment of the acquisition unit (1) on the product presentation device (15).

10. Acquisition unit (1) according to claim 1, which comprises an electric energy store (29) and is designed to approach an energy supply zone (19) within the product presentation device (15) by means of its movement device (2) when the state of charge of its electric energy store (29) undershoots a predefined level.

11. Product presentation device (15), in particular shelf rack or table, which comprises:
at least one acquisition unit (1) according to any of the preceding claims 1-10,
at least one preparation zone (16a-16h) which is provided for self-propelled movement of the acquisition unit (1), wherein the preparation zone (16a-16h) is formed with regard to its surface composition and/or its material composition in such a way that the acquisition unit (1) is autonomously held or attached thereto by means of its holding or attachment device (10).

12. Product presentation device (15) according to claim 11, which, in addition to the at least one preparation zone (16a-16h) provided for moving the acquisition unit (1), comprises a product presentation zone (25a-25b) for presenting products (26a-26d), which differs from the preparation zone (16a-16h).

13. Product presentation device (15) according to claim 12, wherein the product presentation device (15) comprises at least one shelf (20a, 20b) and wherein the preparation zone (16a-16h) is at least partially formed from a side of a rear wall of the shelf (20a, 20b) facing toward the product presentation zone (25a-25b) and/or a ceiling of the shelf (20a, 20b).

14. Product presentation device (15) according to claim 11, wherein at least two differently oriented preparation zones (16a-16h) are provided, which are connected to each other with a transition element, the transition element being designed in such a way that a translation from the one preparation zone (16a-16h) to the other preparation zone (16a-16h) is enabled by means of the movement device (2) of the acquisition unit (1).

15. Product presentation device (15) according to claim 11, which comprises an energy supply zone (19), wherein the product presentation device (15) is designed such that the energy supply zone (19) can be approached by the acquisition unit (1) by means of the latter's movement device (2).

16. Product presentation device (15) according to claim 15, wherein the energy supply zone (19) comprises a charging station (18), by means of which, preferably by means of contactless energy transmission, the acquisition unit (1) can be supplied with electrical energy.
